(19) United States
(12) Patent Application Publication
(10) Pub. No.: US 2013/0029629 A1
(43) Pub. Date: Jan. 31, 2013

(54) Methods and Apparatus for Enabling Access Transfer of an Emergency Call Back Session

(71) Applicants: Fredrik Lindholm, Stockholm (SE); Ivo Sedlacek, Landskrona (SE)

(72) Inventors: Fredrik Lindholm, Stockholm (SE); Ivo Sedlacek, Landskrona (SE)

(73) Assignee: Telefonaktiebolaget L M Ericsson (publ), Stockholm (SE)

(21) Appl. No.: 13/198,368

(22) Filed: Aug. 4, 2011

Related U.S. Application Data
(63) Continuation of application No. PCT/EP2011/063092, filed on Jul. 29, 2011.

(51) Int. Cl. H04M 11/04

(52) U.S. Cl. 455/404.1

(57) ABSTRACT

According to an embodiment of the present invention there is provided a method of enabling Single Radio Voice Call Continuity, SRVCC, access transfer for an emergency call back IP Multimedia Subsystem, IMS, session to a user equipment, UE. The method comprises including a session continuity function in a signalling path of a request for establishment of a call back session intended for the UE, and if access transfer of the call back session from a packet switched access to a circuit switched access is required, implementing SRVCC access transfer of the call back session using the session continuity function.

### CROSS REFERENCE TO RELATED APPLICATION

The present application claims priority to PCT International Application No. PCT/EP2011/063092, filed Jul. 29, 2011, the disclosure of which is incorporated herein by reference as if set forth fully herein.

### TECHNICAL FIELD

The present invention relates to methods and apparatus for enabling access transfer of an emergency call back session in an IP Multimedia Subsystem. More particularly, the invention relates to methods and apparatus for enabling Single Radio Voice Call Continuity of an emergency call back session.

### BACKGROUND

IP Multimedia (IPMM) services provide a dynamic combination of voice, video, messaging, data, etc, within the same session. By growing the numbers of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

IP Multimedia Subsystem (IMS) is the technology defined by the Third Generation Partnership Project (3GPP) to provide IP Multimedia services over mobile communication networks. IMS provides key features to enrich the end-user person-to-person communication experience through the integration and interaction of services. IMS allows new rich person-to-person (client-to-client) as well as person-to-content (client-to-server) communications over an IP-based network. The IMS makes use of the Session Initiation Protocol (SIP) to set up and control calls or sessions between user terminals (or user terminals and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly. Other protocols are used for media transmission and control, such as Real-time Transport Protocol and Real-time Transport Control Protocol (RTP/RTCP),

FIG. 1 illustrates schematically how the IMS fits into the mobile network architecture in the case of a General Packet Radio Service (GPRS) access network. As shown in FIG. 1 control of communications occurs at three layers (or planes). The lowest layer is the Connectivity Layer 1, also referred to as the bearer plane and through which signals are directed to/from user equipment (UE) accessing the network. The entities within the connectivity layer 1 that connect an IMS subscriber to IMS services form a network that is referred to as the IP-Connectivity Access Network, IP-CAN. The GPRS network includes various GPRS Support Nodes (GSNs). A gateway GPRS support node (GGSN) 2 acts as an interface between the GPRS backbone network and other networks (radio network and the IMS network). The middle layer is the Control Layer 4, and at the top is the Application Layer 6.

The IMS 3 includes a core network 3a, which operates over the middle, Control Layer 4 and the Connectivity Layer 1, and a Service Network 3b. The IMS core network 3a includes nodes that send/receive signals to/from the GPRS network via the GGSN 2a at the Connectivity Layer 1 and network nodes that include Call/Session Control Functions (CSCFs) 5, which operate as SIP proxies within the IMS in the middle, Control Layer 4. The 3GPP architecture defines three types of CSCFs: the Proxy CSCF (P-CSCF) which is the first point of contact within the IMS for a SIP terminal; the Serving CSCF (S-CSCF) which provides services to the user that the user is subscribed to; and the Interrogating CSCF (I-CSCF) whose role is to identify the correct S-CSCF and to forward to that S-CSCF a request received from a SIP terminal via a P-CSCF. The top, Application Layer 6 includes the IMS service network 3b. Application Servers (ASs) 7 are provided for implementing IMS service functionality.

FIG. 2 illustrates schematically the IMS network architecture for implementing IMS emergency services, which includes an Emergency CSCF (E-CSCF), a Location Retrieval Function (LRF), and an Emergency Access Transfer Function (EATF). For simplicity, not all functional components of the IMS, e.g. IBCF, MGCF and BGCF, are shown in this figure. When an emergency call is placed using a UE, it is normally routed from the P-CSCF to an E-CSCF. The E-CSCF is concerned with handling emergency sessions, and is responsible for the routing of emergency calls to the correct emergency centre or Public Safety Answering Point (PSAP). The E-CSCF has an interface to a LRF, and the E-CSCF can request the LRF to retrieve location information relating to a UE that has initiated an IMS emergency session. The E-CSCF also has an interface to an EATF. The EATF enables service continuity of IMS emergency sessions. The P-CSCF, EATF and E-CSCF are always located in the same serving network, which is the visited network when the UE is roaming.

Single Radio Voice Call Continuity (SRVCC), described in 3GPP TS 23.237 and 3GPP TS 23.216, allows handover of a voice call from a packet switched access to a circuit switched access (e.g. transfer of a VoIP IMS session from an E-UTRAN to a UTRAN/GERAN). When an IMS emergency session is used in combination with SRVCC, the E-CSCF invokes an EATF that anchors the emergency session in the serving network, and in the event of transfer of the session to a circuit switched access network, the EATF ensures that the new call leg over the circuit switched access (i.e. the Target Access Leg) is correlated with the ongoing session and transferred correctly.

As part of IMS emergency services it is also a requirement that, when a UE has had an emergency session with an emergency centre or PSAP, the emergency centre or PSAP should be able to request a call back session to the UE, if the UE is registered. To do so, the PSAP can return a call to the UE, via the S-CSCF in the home network, using existing basic call procedures. FIG. 3 is a signalling flow diagram illustrating an example of an IMS emergency registration, an emergency call session and a subsequent emergency call back session. As illustrated in FIG. 3, when an IMS emergency registration with the home network is performed, for example, because the UE is connected to a visited network or because the UE is connected to the home network but is not already registered, the S-CSCF will not perform a third party registration with an Application Server (such as a SCC AS) to inform these about the registration. As such, no Application Servers are aware that the user is registered. In contrast, during a normal IMS registration, the S-CSCF will perform a third party registration with any relevant Application Servers in order to inform them about the user's registration. As a result, if access transfer of an emergency call back from a PSAP is required following an IMS emergency registration, then the SRVCC procedures will. This is because a call back from the PSAP will be routed to the S-CSCF in the home network, and the S-CSCF will route the call via the P-CSCF to the UE, in accordance with the IMS emergency registration (e.g. via only those entities that were included in the Path header filed of the SIP REGISTER request message). As such, the EATF will not be included in the path, and any Service Centralization and Continuity Application Server (SCC AS) that may be included in the path will not be aware of the IMS emergency registration.

### SUMMARY

It is an object of some embodiments of the present invention to enable access transfer of an emergency call back session in an IP Multimedia Subsystem.

According to a first embodiment of the present invention there is provided a method of operating a Call Session Control Function (CSCF) of an IP Multimedia Subsystem (IMS) network. The method comprises participating in IMS emergency registration of a user equipment (UE), receiving a session establishment request for establishment of an emergency call back session intended for the UE, and forwarding the request for establishment of an emergency call back session towards a session continuity function, the session continuity function providing session continuity for IMS sessions that require access transfer from a packet switched access to a circuit switched access. When participating in IMS emergency registration of the UE, the CSCF is included in the routing of a request for IMS emergency registration of the UE.

The CSCF may be a Serving Call Session Control Function (S-CSCF) located within a home IMS of the UE.

The method may further comprise receiving a request for IMS emergency registration of the UE from the session continuity function, the request for IMS emergency registration including an address of the session continuity function, storing the address of the session continuity function, and, for any subsequently received request that is intended for the UE, determining if the request relates to an emergency call back session and, if so, forwarding the request to the address of the session continuity function. The address of the session continuity function may be included in a Path header field of the received request for IMS emergency registration.

The session continuity function may be an Access Transfer Control Function (ATCF) located in a serving network providing the UE with access to the home IMS. The method may then further comprise, forwarding the request for establishment of the emergency call back session to the ATCF. If the request for IMS emergency registration of the UE includes a routing number (STN-SR) pointing to the ATCF, then the method may further comprise, ensuring that the routing number can be provided to a circuit switched access should access transfer of any subsequent emergency call back sessions from a packet switched access to the circuit switched access be required. The step of ensuring that the routing number can be provided to a circuit switched access may comprise including the routing number in a third party registration of the UE sent to a Service Centralization and Continuity Application Server (SCC AS).

The session continuity function may be an Emergency Access Transfer Function, EATF, located in a serving network providing the UE with access to the home IMS. The method may then further comprise, upon receipt of a request for establishment of the emergency call back session, forwarding the request for establishment of the emergency call back session to the EATF.

The CCSF may be a Proxy Call Session Control Function (P-CSCF) located in a serving network that is providing the UE with access to the home IMS. The method may then further comprise, following IMS emergency registration of the UE, for any received request that is intended for the UE, determining if the request has been routed over the IMS emergency registration, and if so, forwarding the request towards the session continuity function.

The session continuity function may then be an Emergency Access Transfer Function (EATF) located in the serving network. The step of forwarding the request towards the session continuity function may then comprise sending the request for establishment of an emergency call back session to an Emergency Call Session Control Function (E-CSCF) located in the serving network, such that the E-CSCF can forward the request to an EATF. Alternatively, the method may further comprise, following IMS emergency registration of the UE, receiving a response to a request for establishment of an emergency call session intended for the UE from an E-CSCF located in the serving network, the response including the address of an EATF. The can then be the address of the EATF, such that the step of forwarding the request towards the session continuity function may comprise forwarding the request to the stored address of the EATF.

According to a second embodiment of the present invention there is provided a method of operating a session continuity function of an IP Multimedia Subsystem (IMS) network, the session continuity function providing session continuity for IMS sessions that require access transfer from a packet switched access to a circuit switched access supporting access. The method comprises receiving a request for IMS emergency registration of a UE, including the address of the session continuity function in the request for IMS emergency registration, and forwarding the request for IMS emergency registration towards a home IMS of the UE. The inclusion of the address of the session continuity function in the request for IMS emergency registration ensures that a subsequent emergency call back session involving the UE will be routed via the session continuity function. If access transfer of the emergency call back session from a packet switched access to a circuit switched access is required, the session continuity function can then implement the access transfer of the emergency call back session.

The step of including the address of the session continuity function in the request for IMS emergency registration may comprise including an address of the session continuity function in a Path header field of the request for IMS emergency registration.

The session continuity function may be an Access Transfer Control Function (ATCF) located in a serving network providing the UE with access to the home IMS. Prior to forwarding the request for IMS emergency registration of the UE, the method may then further comprise including a routing number (STN-SR) pointing to the ATCF in the request for IMS registration, thereby ensuring that the routing number can be provided to a circuit switched access should access transfer of any subsequent IMS session from a packet switched access to the circuit switched access be required.

The session continuity function may be an Emergency Access Transfer Function (EATF) located in the serving network.

According to a third embodiment of the present invention there is provide method of operating a Proxy Call Session Control Function (P-CSCF) of an IP Multimedia Subsystem (IMS). The method comprises receiving a request for IMS emergency registration of a UE, and forwarding the request for IMS emergency registration to a session continuity function.

The session continuity function may be an Access Transfer Control Function (ATCF) located in the IMS network.

Alternatively, the session continuity function may be an Emergency Access Transfer Function (EATF) located in the IMS network. The method may then further comprise receiving a request for establishment of an emergency call session from the UE, including an address of the EATF in the request, and forwarding the request to an Emergency Call Session Control Function (E-CSCF) located in the serving network.

According to a fourth embodiment of the present invention there is provide an apparatus configured to operate as a Call Session Control Function (CSCF) of an IP Multimedia Subsystem (IMS) network. The apparatus comprises a processor for participating in IMS emergency registration of a UE, a receiver for receiving a session establishment request for establishment of an emergency call back session intended for the UE; and a transmitter for forwarding the request for establishment of an emergency call back session towards a session continuity function, the session continuity function providing session continuity for IMS sessions that require access transfer from a packet switched access to a circuit switched access.

The apparatus may be configured to operate as a Serving Call Session Control Function (S-CSCF) for location within a home IMS of the UE.

The receiver may be further configured to receive a request for IMS emergency registration of the UE from the session continuity function, the request for IMS emergency registration including an address of the session continuity function. The apparatus may then further comprise a memory for storing the address of the session continuity function. The processor may then be configured to, determine if any subsequently received request that is intended for the UE relates to an emergency call back session and, if so, to ensure that the request is forwarded to the address of the session continuity function that is stored in the memory.

The processor may be further configured to ensure that the request for establishment of an emergency call back session is sent to an Access Transfer Control Function (ATCF) located in a serving network providing the UE with access to the home IMS, using the transmitter. The processor may then be further configured to, if the request for IMS emergency registration of the UE includes a routing number (STN-SR) pointing to the ATCF, include the routing number in a third party registration of the UE sent to a Service Centralization and Continuity Application Server (SCC AS).

The apparatus may be configured to operate as a Proxy Call Session Control Function (P-CSCF) for location within a serving network that is providing the UE with access to a home IMS. The processor may then be configured to determine if any received request that is intended for the UE has been routed over the IMS emergency registration and, if so, to ensure that the request is forwarded towards the session continuity function.

The processor may be configured to ensure that the request for establishment of an emergency call back session is sent to an E-CSCF located in the serving network, such that the E-CSCF can forward the request to an EATF.

The transmitter may be configured to receive a response to a request for establishment of an emergency call session intended for the UE from an E-CSCF, located in the serving network, the response including the address of an EATF; and the apparatus may further comprise a memory for storing the address of the EATF. The processor may be configured to ensure that the request for establishment of an emergency call back session is sent to the stored address of the EATF.

According to a fifth embodiment of the present invention there is provide an apparatus configured to operate as a session continuity function of an IP Multimedia Subsystem (IMS) network the session continuity function providing session continuity for IMS sessions that require access transfer from a packet switched access to a circuit switched access supporting access. The apparatus comprises a receiver for receiving a request for IMS emergency registration of a UE, a processor for including the address of the session continuity function in the request for IMS emergency registration such that a subsequent request for an emergency call back session involving the UE will be routed via the session continuity function, and a transmitter for forwarding the request for IMS emergency registration towards a home IMS of the UE.

The processor may be configured to include an address of the session continuity function in a Path header field in the request for IMS emergency registration.

The apparatus may be configured to operate as an Access Transfer Control Function (ATCF). The processor may then be further configured to include a routing number (STN-SR) pointing to the ATCF in the request for IMS registration, prior to sending the request for IMS emergency registration to the home IMS.

The apparatus may be configured to operate as an Emergency Access Transfer Function (EATF).

According to a sixth embodiment of the present invention there is provide an apparatus configured to operate as a Proxy Call Session Control Function (P-CSCF) of an IP Multimedia Subsystem (IMS) network. The apparatus comprises a receiver for receiving a request for IMS emergency registration of a UE, and a transmitter for forwarding the request for IMS emergency registration to a session continuity function.

The processor may be configured to ensure that the request for IMS emergency registration is sent towards an Access Transfer Control Function (ATCF) located in the IMS network, using the transmitter.

The processor may be configured to ensure that the request for IMS emergency registration is sent towards an Emergency Access Transfer Function (EATF) located in the IMS network, using the transmitter.

According to a further embodiment there is provided a computer program comprising computer program code means adapted to perform all the steps of one of the first aspect, second aspect and third aspect when said program is run on a computer. According to a yet further aspect there is provided a computer program according to the further aspect embodied on a computer readable medium.

According to another embodiment of the present invention there is provided a method of enabling Single Radio Voice Call Continuity, SRVCC, access transfer for an emergency call back IP Multimedia Subsystem, IMS, session intended for a UE that has an IMS emergency registration. The method comprises including a session continuity function in a signalling path of a request for establishment of a call back session intended for the UE, and if access transfer of the call back session from a packet switched access to a circuit switched access is required, implementing SRVCC access transfer of the call back session using the session continuity function.

### BRIEF DESCRIPTION OF THE DRAWINGS

FIG. 1 illustrates schematically an IMS network in association with a mobile network architecture of a General Packet Radio Service (GPRS) access network;

FIG. 2 illustrates schematically the IMS network architecture for implementing IMS emergency services;

FIG. 3 is a signalling flow diagram illustrating an example of an IMS emergency registration, an emergency call session and a subsequent emergency call back session;

FIG. 4 is a signalling flow diagram illustrating an example of a solution for enabling access transfer of an emergency call back session;

FIG. 5 is a signalling flow diagram illustrating an example of an alternative solution for enabling access transfer of an emergency call back session;

FIG. 6 is a signalling flow diagram illustrating an example of a further alternative solution for enabling access transfer of an emergency call back session;

FIG. 7 illustrates schematically an example of an Call Session Control Function suitable for implementing the methods described herein; and

FIG. 8 illustrates schematically an example of a session continuity function suitable for implementing the methods described herein.

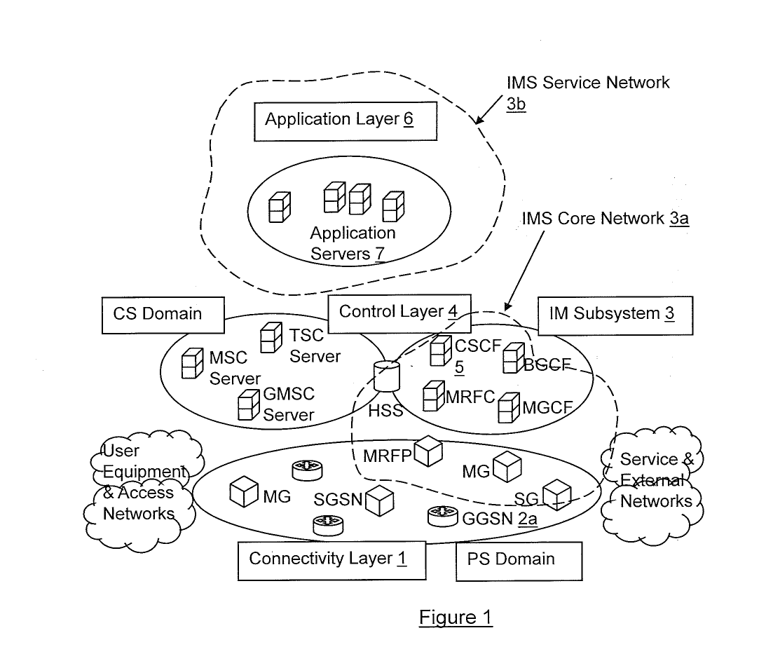

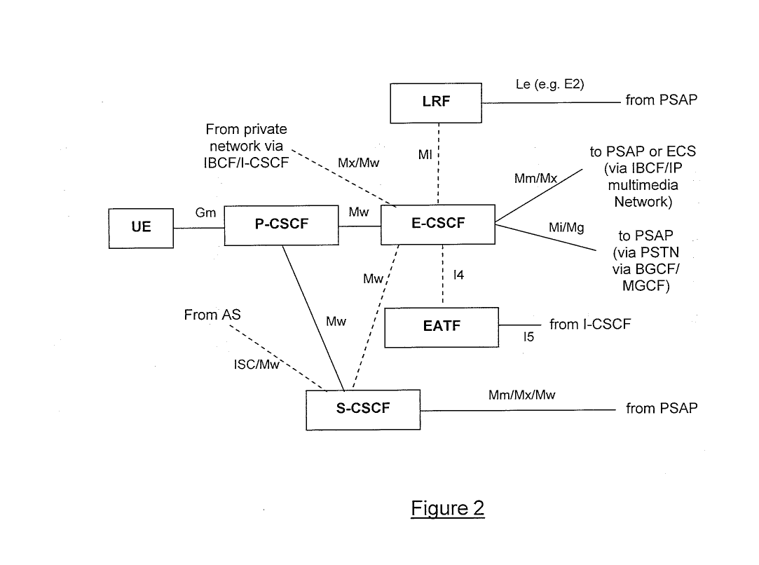

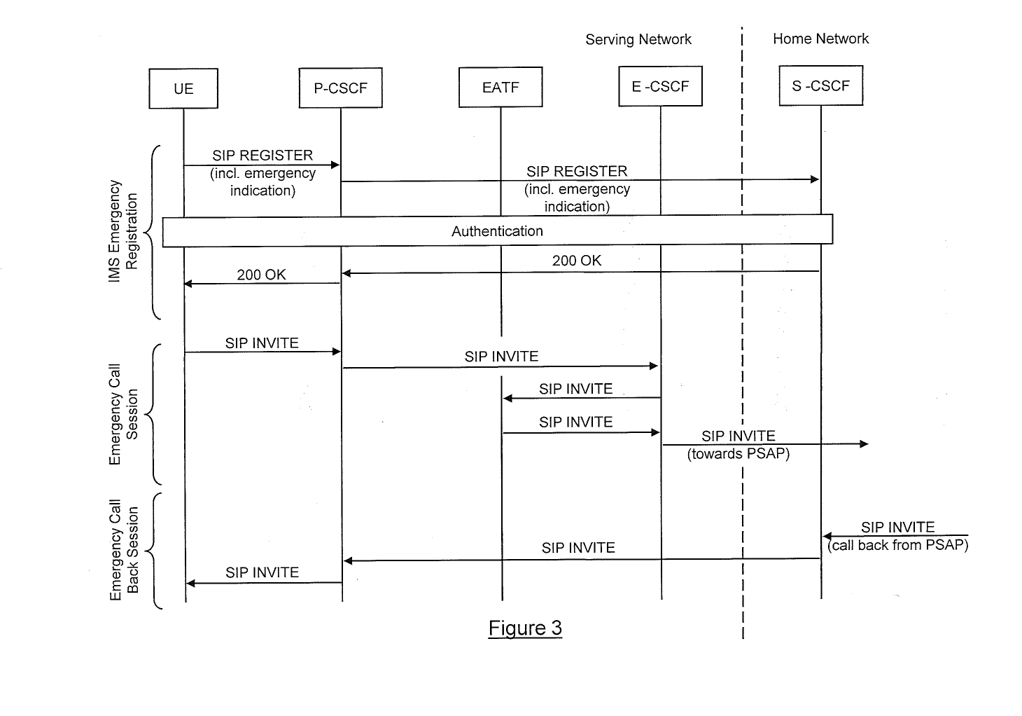

### DETAILED DESCRIPTION

In order to overcome the problems identified above there will now be described a method of enabling access transfer of an IMS emergency call back session following an IMS emergency registration. The method involves having a Call Session Control Function (CSCF) within either a serving network (i.e. visited network if roaming) or a home network identify that a request, intended for UE that has an emergency registration, relates to emergency call back session and therefore include a session continuity function (which could also be referred to as an access transfer function) in the signalling path of the request. The session continuity function can therefore provide session continuity should access transfer from a packet switched access to a circuit switched access be required during the emergency call back session, and can be either an IMS Access Transfer Control Function (ACTF) or Emergency Access Transfer Function (EATF).

In this regard, it has been recognised here that there are a number of ways in which this could be achieved. Firstly, an ATCF could be included in the signalling path during the emergency registration of the UE, and could thereby ensure that it is also included in the signalling path of any emergency call back session that is intended for the UE (and that will therefore be routed over the emergency registration). The ATCF can then detect an emergency call back session and can ensure that any access transfer that is required during the emergency call back session can be implemented. Alternatively, an EATF could be included in the signalling path during the emergency registration of the UE, and could thereby ensure that it is also included in the signalling path of any emergency call back session that is intended for the UE (and that will therefore be routed over the emergency registration). The EATF can then detect an emergency call back session and can ensure that any access transfer that is required during the emergency call back session can be implemented. As a further alternative, an EATF need not be included in the signalling path during emergency registration of the UE, but any subsequent attempt to establish an emergency call back session with the UE, that will therefore be initially routed over the emergency registration, could then be routed via the EATF such that any access transfer that is required during the emergency call back session can be implemented.

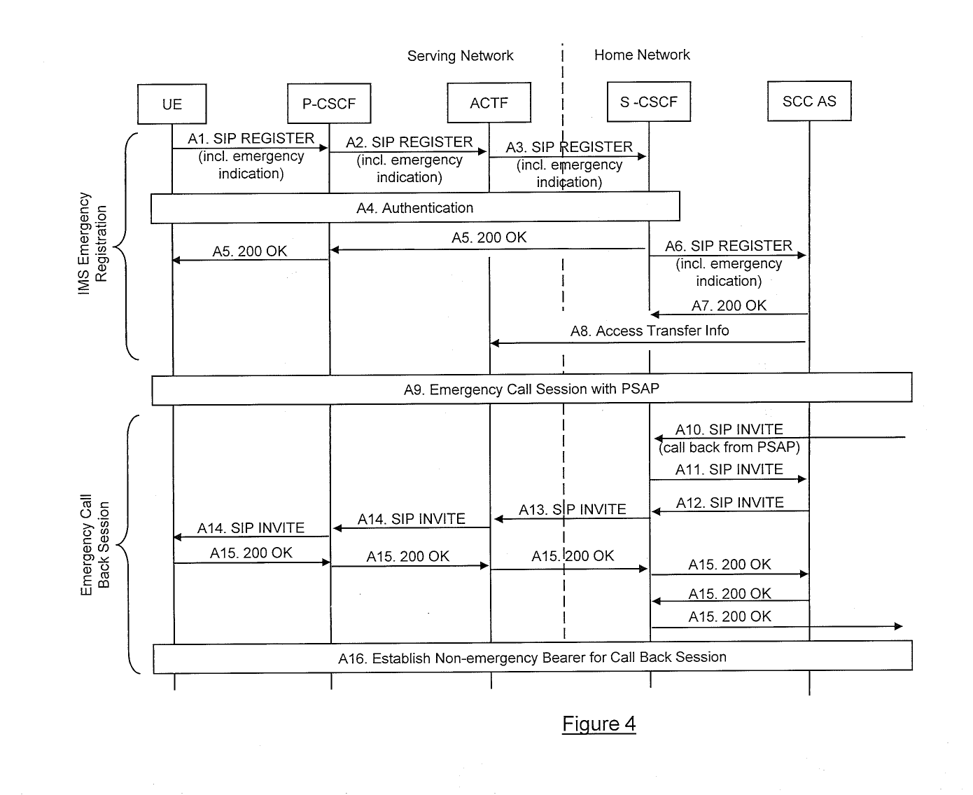

FIG. 4 is a signalling flow diagram illustrating an example of a solution for enabling access transfer of an emergency call back session in an IMS in which an ACTF in the serving network is included in the path of any emergency call back session. The steps performed are as follow:
A1. A UE located within a serving network (visited network if roaming) initiates an IMS emergency registration by sending a SIP REGISTER request message towards its home network, the SIP REGISTER message including an emergency indication. The SIP REGISTER message may also include a “sip.instance” media feature tag in the Contact header field, the value of which is a Uniform Resource Name (URN) that uniquely identifies the specific instance of a SIP User Agent (UA) that is provided by the UE,
A2. A P-CSCF within the serving network receives the SIP REGISTER request message including the emergency indication. Rather than forwarding the SIP REGISTER directly to an S-CSCF in the home network, in accordance with the current emergency registration procedures, the P-CSCF forwards this message to an ATCF within the serving network.
A3. The ATCF receives the SIP REGISTER request message including the emergency indication. The ATCF will store the “sip.instance” media feature tag that was included in the SIP REGISTER request message for the user. The ATCF recognises the emergency registration and adds a Uniform Resource Identifier (URI) addressing the ACTF into the Path header field of the SIP REGISTER request message, thereby ensuring that any requests sent to the UE over the emergency registration will be routed through the ATCF. To be able to subsequently correlate the emergency call back session with the emergency registration, and thereby determine the “sip.instance” for the UE, the ATCF can construct the Path header field value such that that it is unique for the user's IMS emergency registration. For example, the ATCF can include a URI having a user part that uniquely identifies the user's IMS emergency registration, or can include a parameter in the Path header field value that uniquely identifies user's IMS emergency registration. In addition, the ATCF also includes a Session Transfer Number for SRVCC (STN-SR) pointing to the ATCF (i.e. a routing number indicating the ATCF) in the SIP REGISTER request message. For example, the ATCF could insert the g.3gpp.atcf media feature tag containing the STN-SR allocated to ATCF into the Path header field of the SIP REGISTER request message.
A3. The ATCF then forwards the SIP REGISTER request message including the emergency indication to an S-CSCF in the home network of the UE.
A4. The S-CSCF receives the SIP REGISTER request message including the emergency indication. The S-CSCF then authenticates the UE in the same way as for any other IMS registration.
A5. After successful registration of the UE, the S-CSCF stores the addresses that were included in the Path header field of the SIP REGISTER request message. The S-CSCF will then send a SIP 200 OK response message back to the UE to indicate that the emergency registration was successful. The SIP 200 OK response message is routed back to the UE via the entities identified in the Path header field of the SIP REGISTER request message, which includes the ATCF and P-CSCF in the serving network.
A6. The S-CSCF also sends a third party SIP REGISTER request message including the emergency indication to a SCC AS within the home network, with which the S-CSCF registers the user with the SCC AS on the user's behalf. The third party SIP REGISTER request message includes the contents of the SIP REGISTER request message received by the S-CSCF. For example, 3GPP TS 24.229 Rel-10 section 5.4.1.7 sets out procedures regarding the inclusion by the S-CSCF of the contents of an incoming SIP REGISTER request in the body of a third party SIP REGISTER request.
A7. The SCC AS receives the third party SIP REGISTER request message and stores the STN-SR pointing to the ATCF for the duration of this registration. The SCC AS will also store the emergency indication information such that the SCC AS can distinguish this registration from any normal IMS registration of the UE. In doing do, the SCC AS can ensure that it will not route normal incoming calls over the IMS emergency registration. If required, the SCC AS can also update the STN-SR stored in the HSS for the UE. The SCC AS responds to the S-CSCF with a SIP 200 OK response message.
A8. After the registration, the SCC AS provides Access Transfer Information to the ATCF, by sending a message including an Access Transfer Update—Session Transfer Identifier (ATU-STI) and a Correlation MSISDN (C-MSISDN). To do so, the SCC AS may retrieve the C-MSISDN from the user profile stored in a HSS. The C-MSISDN is an MSISDN that is used for correlation of sessions at access transfer, and to route a call from the IMS CN subsystem to the same user in the CS domain. The C-MSISDN is bound to the IMS Private User Identity and is uniquely assigned per IMSI and IMS Private User Identity.
A9. Subsequently, the UE establishes an emergency call session with a PSAP (not shown) according to standard procedures.
A10. At some point after termination of the emergency call session, a PSAP initiates the establishment of an emergency call back session with the UE by sending a SIP INVITE request message towards the UE. The SIP INVITE may include an information element that indicates that the INVITE relates to an IMS emergency call back from a PSAP.
A11. The S-CSCF receives the SIP INVITE request message and identifies the request as relating to an emergency call back session. The S-CSCF therefore performs the required invocation of services (e.g. using initial Filter Criteria), where the SCC AS will be the last service invoked. The S-CSCF forwards the SIP INVITE request to the SCC AS.
A12. The SCC AS receives the SIP INVITE request message and detects that the request relates to an emergency call back session. The SCC AS determines that the session should be routed over the signalling path of the emergency registration. The SCC AS therefore anchors the session and forwards the SIP INVITE request message back to the S-CSCF.
A13. The S-CSCF receives the SIP INVITE request message from the SCC AS and forwards the SIP INVITE request message towards the UE over the emergency registration. The S-CSCF therefore sends the SIP INVITE request message to the ATCF, as the address of the ATCF is the top entry in the Path header field of the SIP REGISTER message received during the emergency registration.
A14. The ATCF receives the SIP INVITE request message and detects that the request relates to an emergency call back session. The ATCF therefore anchors the session and forwards the SIP INVITE request message to the UE via the P-CSCF in the serving network.
A15. In order to accept the session, the UE sends a SIP 200 OK response message back towards the PSAP. The SIP 200 OK response message is then routed back to the PSAP via the P-CSCF and ATCF in the serving network, and the S-CSCF and SCC AS in the home network.
A16. Following receipt of the SIP 200 OK (or a previous SIP 18× provisional response), the P-CSCF performs setup of the resources in the network for the UE. In this case, the P-CSCF should not create a special emergency bearer for the UE but should instead create a voice bearer with special priority using the multimedia priority procedures. By setting up a normal (i.e. non-emergency) bearer, any required access transfer will initiate standard non-emergency SRVCC procedures, such that the STN-SR will be used to locate ATCF in order to implement the access transfer.

If the procedures outlined above have been implemented, then any required access transfer of the emergency call back session will initiate the implementation of SRVCC procedures using the STN-SR pointing to the ATCF. This STN-SR will be provided to an MSC Server in the circuit switched access (e.g. by an MME/SGSN in the packet switched access). The ATCF and the SCC AS will also use the C-MSISDN (or instance ID if present) for the correlation of the session in the packet switched access with the session in the circuit switched access. This alternative solution provides the advantage that the home network (e.g. an SCC AS) is included in an emergency call back session, such that the home network can be involved in determining whether SRVCC procedures should be implemented for any session continuity/access transfer that is required for the emergency call back session.

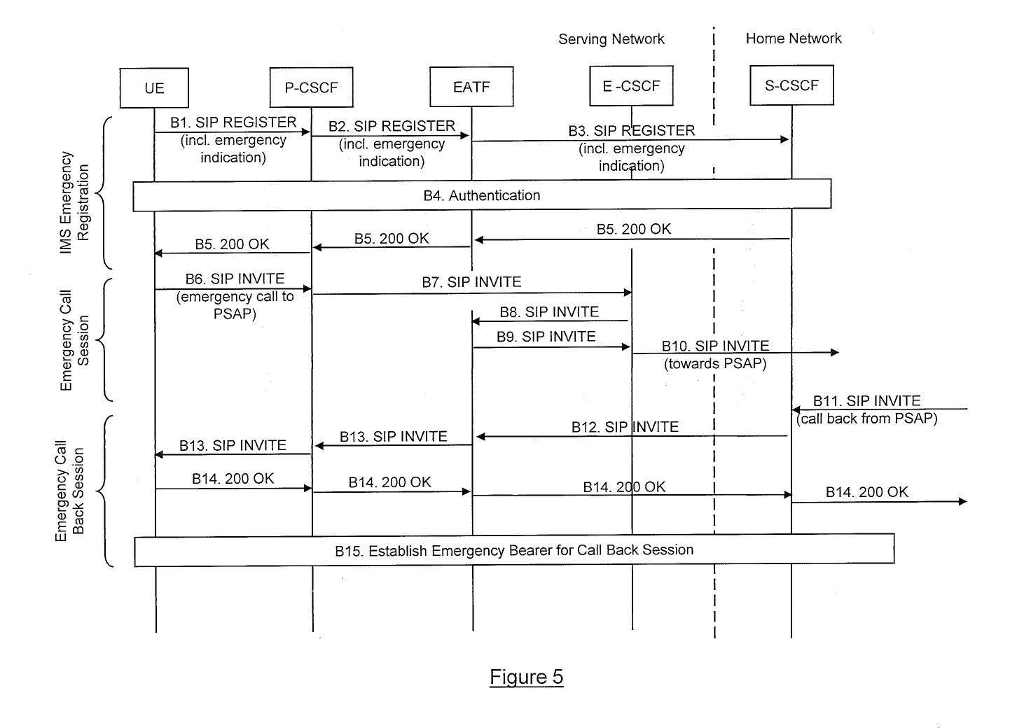

As an alternative to the solution described with reference to FIG. 4, FIG. 5 is a signalling flow diagram illustrating an example of a solution for enabling access transfer of an emergency call back session in an IMS in which an EATF in the serving network is included in the signalling path of any emergency call back session. The steps performed are as follow:
B1. A UE located within a serving network (visited network if roaming) initiates an IMS emergency registration by sending a SIP REGISTER request message towards its home network, the SIP REGISTER message including an emergency indication. The SIP REGISTER message also includes a “sip.instance” media feature tag in the Contact header field, which uniquely identifies the specific instance of a SIP UA that is provided by the UE.
B2. A P-CSCF within the serving network receives the SIP REGISTER request message including the emergency indication. Rather than forwarding the SIP REGISTER directly to an S-CSCF in the home network, in accordance with the current emergency registration procedures, the P-CSCF forwards this message to an EATF within the serving network.
B3. The EATF receives the SIP REGISTER request message including the emergency indication. The EATF recognises the emergency registration and adds a Uniform Resource Identifier (URI) addressing the EATF into the Path header field of the SIP REGISTER request message. In doing so, the EATF ensures that any requests sent to the UE over the emergency registration will be routed through the EATF. The EATF will also store the “sip.instance” media feature tag that was included in the SIP REGISTER request message for the user. To be able to subsequently correlate the emergency call back session with the emergency registration, and thereby determine the “sip.instance” for the UE, the EATF can construct the Path header field value such that that it is unique for the user's IMS emergency registration. For example, the EATF can include a URI having a user part that uniquely identifies the user's IMS emergency registration, or can include a parameter in the Path header field value that uniquely identifies user's IMS emergency registration.
B3. The EATF then forwards the SIP REGISTER request message including the emergency indication to an S-CSCF in the home network of the UE.
B4. The S-CSCF receives the SIP REGISTER request message including the emergency indication. The S-CSCF then authenticates the UE in the same way as for any other IMS registration.
B5. After successful registration of the UE, the S-CSCF stores the addresses that were included in the Path header field of the SIP REGISTER request message. The S-CSCF will then send a SIP 200 OK response message back to the UE to indicate that the emergency registration was successful. The SIP 200 OK response message is routed back to the UE via the entities identified in the Path header field of the SIP REGISTER request message, which includes the EATF and P-CSCF in the serving network. For any subsequent requests received by the S-CSCF that are intended for the UE, and that the S-CSCF identifies as relating to an emergency call back session, the S-CSCF will then route the request via the emergency registration of the UE, such that those entities whose addresses were included in the Path header field of the SIP REGISTER request message will be included in the path of the request.
B6. Subsequently, the UE initiates the establishment of an emergency call session with a PSAP (not shown) by sending a SIP INVITE request message including an emergency service URN.
B7. The P-CSCF within the serving network receives the SIP INVITE request message including the emergency indication and detects that the request relates to an emergency call session. The P-CSCF can therefore include the address of the EATF to which it previously forwarded the SIP REGISTER request message during the emergency registration, and forwards this message to an E-CSCF within the serving network.
B8. The E-CSCF receives the SIP INVITE request message including the emergency indication and the address of the EATF and forwards the message to the EATF identified in the SIP INVITE.
B9. The EATF receives the SIP INVITE request message and anchors the emergency call session. The EATF returns the SIP INVITE request message back to the E-CSCF.
B10. The E-CSCF then forwards the SIP INVITE request message to a PSAP.
B11. At some point after termination of the emergency call session, the PSAP initiates the establishment of an emergency call back session with the UE by sending a SIP INVITE request message towards the UE. The SIP INVITE may include an information element that indicates that the INVITE relates to an IMS emergency call back from a PSAP.
B12. The S-CSCF in the home network receives the SIP INVITE request message, detects that the request relates to an emergency call back session, and therefore forwards the SIP INVITE request message towards the UE over the emergency registration (and not towards any normal IMS registrations). The S-CSCF therefore forwards the SIP INVITE request to the UE via the entities identified in the Path header field of the SIP REGISTER request message related to the IMS emergency registration, which includes the EATF and P-CSCF in the serving network.
B13. The EATF receives the SIP INVITE request message and detects that the request relates to an emergency call back session. The EATF identifies the called user and the IMS emergency registration using the information in the SIP INVITE, including the value received in top Route header field (which corresponds to the value of the Path header field value included in the SIP REGISTER request message). The EATF can then identify the specific instance of a SIP UA (i.e. the “sip.instance”) previously stored during the IMS emergency registration. The SIP instance is later required for correlation of the sessions during the emergency SRVCC procedures. The EATF anchors the session and forwards the SIP INVITE request message to the UE via P-CSCF in the serving network.
B14. In order to accept the session, the UE sends a SIP 200 OK response message back towards the PSAP. The SIP 200 OK response message is then routed back to the PSAP via the P-CSCF and EATF in the serving network, and the S-CSCF in the home network.
B15. Following receipt of the SIP 200 OK (or a previous SIP 18× provisional response), the P-CSCF then performs setup of the resources in the network for the UE. In this case, the P-CSCF should create a special emergency bearer for the UE. When compared with a non-emergency bearer, an emergency bearer is tagged differently in the access network, such that it can be handled separately from normal bearers. For example, if there a congestion situation in the network, then the emergency bearers can be given priority over normal bearers. In doing so, the emergency call can continue without interruption while the normal calls may be interrupted by the congestion. By setting up an emergency bearer, any required access transfer will initiate SRVCC session transfer of IMS emergency session procedures, such that the E-STN-SR that points to the EATF will be used in order to implement the access transfer.

If the procedures outlined above have been implemented, then any required access transfer of the emergency call back session will initiate the implementation of SRVCC of IMS emergency session procedures using the E-STN-SR pointing to the EATF. This E-STN-SR will either be locally configured in an MME/SGSN in the packet switched access and provided to an MSC Server in the circuit switched access, or will be locally configured in the MSC Server in the circuit switched access. Additionally, this will ensure that when the INVITE sent from the MSC Server is received by the EATF, the EATF can correlate this message with the ongoing session using the instance identifier according to existing procedures. This alternative solution provides the advantage that it enables access transfer of an emergency call back session even if the home network does not support SRVCC session transfer or SRVCC session transfer of IMS emergency sessions.

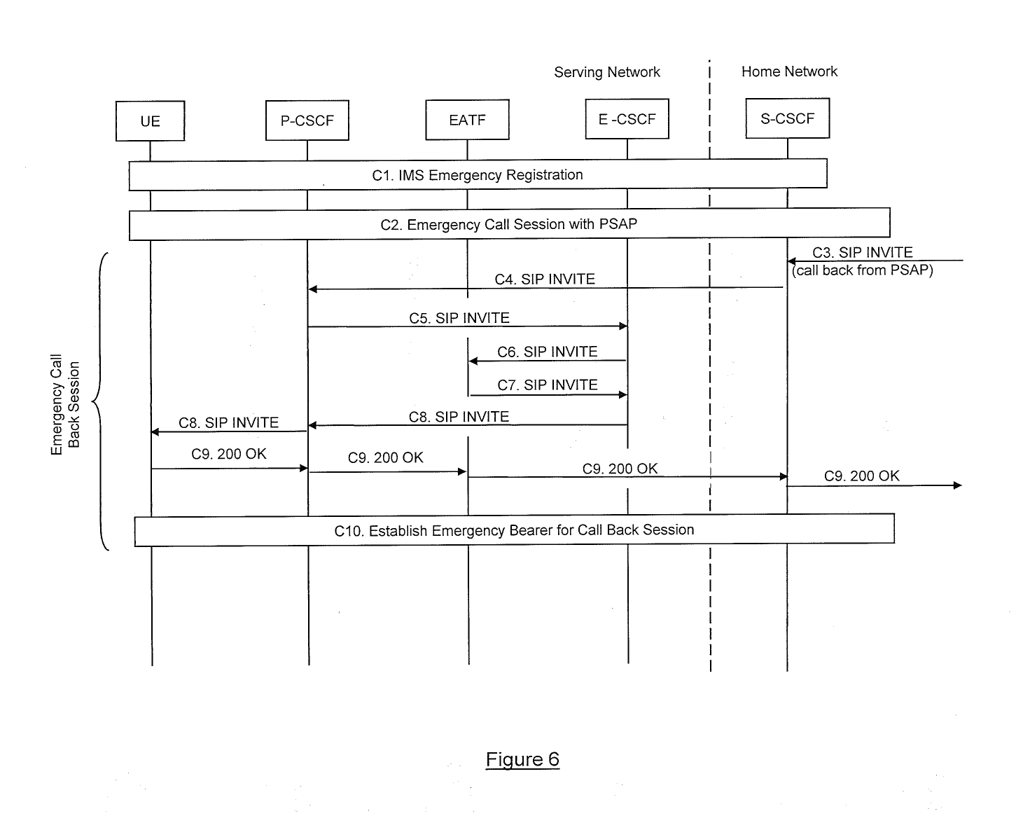

As an alternative to the solutions described with reference to FIG. 4 and FIG. 5, FIG. 6 is a signalling flow diagram illustrating an example of a solution for enabling access transfer of an emergency call back session in an IMS in which an EATF in the serving network is included in the signalling path of any emergency call back session. The steps performed are as follow:
C1. A UE located within a serving network (visited network if roaming) performs an IMS emergency registration to its home network according to standard procedures, by sending a SIP REGISTER request message including an emergency indication. The SIP REGISTER message also includes a “sip.instance” media feature tag in the Contact header field, the value of which is a URN that uniquely identifies the specific instance of a SIP UA that is provided by the UE.
C2. After the IMS emergency registration has been successfully completed, the UE establishes an emergency call session with a PSAP (not shown) according to standard procedures.
C3. At some point after termination of the emergency call session, the PSAP initiates the establishment of an emergency call back session with the UE by sending a SIP INVITE request message towards the UE. The SIP INVITE may include an information element that indicates that the INVITE relates to an IMS emergency call back from a PSAP.
C4. The S-CSCF in the home network receives the SIP INVITE request message, detects that the request relates to an emergency call back session, and therefore forwards the SIP INVITE request message towards the UE over the emergency registration (and not towards any normal IMS registrations). The S-CSCF therefore forwards the SIP INVITE request to the UE via the entities identified in the Path header field of the SIP REGISTER request message associated with the IMS emergency registration, and therefore routes the SIP INVITE request to the P-CSCF in the serving network.
C5. The P-CSCF receives the SIP INVITE request message from the S-CSCF and detects that the request relates to an emergency call back session for the particular UE. The P-CSCF uses normal procedures to find the context stored for the IMS emergency registered UE, which includes the registration data (such as user identifier, sip.instance, contact address etc). The P-CSCF therefore indicates the “sip.instance” of the UE (as was included in the emergency registration request) in the SIP INVITE request message by adding it to one of the existing SIP header fields. As the P-CSCF is aware that the emergency call back session is intended for a UE having an emergency registration, having received the SIP INVITE request message over the emergency registration, rather than forwarding the SIP INVITE directly to the UE in accordance with the current emergency call back session procedures, the P-CSCF routes the SIP INVITE message to an E-CSCF in the serving network. In doing so, the P-CSCF ensures that the SIP INVITE request message will be routed via an EATF.
C6. The E-CSCF receives the SIP INVITE request message including the emergency indication and forwards the message to an EATF in the serving network.
C7. The EATF receives the SIP INVITE request message and detects that the request relates to an emergency call back session. The EATF determines the “sip.instance” of the UE and anchors the session. The SIP instance is later required for correlation of the sessions during the emergency SRVCC procedures. The EATF then sends the SIP INVITE request message back to the E-CSCF in the serving network.
C8. The E-CSCF receives the SIP INVITE request message and forwards the SIP INVITE request message to the UE via the P-CSCF.
C9. In order to accept the session, the UE sends a SIP 200 OK response message back towards the PSAP. The SIP 200 OK response message is then routed back to the PSAP via the P-CSCF and the EATF in the serving network, and the S-CSCF in the home network.
C10. Following receipt of the SIP 200 OK (or a previous SIP 18× provisional response), the P-CSCF then performs setup of the resources in the network for the UE. In this case, the P-CSCF should create a special emergency bearer for the UE. By setting up an emergency bearer, any required access transfer will initiate SRVCC session transfer of IMS emergency session procedures, such that the E-STN-SR that points to the EATF will be used in order to implement the access transfer.

If the procedures outlined above have been implemented, then any required access transfer of the emergency call back session will initiate the implementation of SRVCC of IMS emergency session procedures using the E-STN-SR pointing to the EATF. This E-STN-SR will either be locally configured in an MME/SGSN in the packet switched access and provided to an MSC Server in the circuit switched access, or will be locally configured in the MSC Server in the circuit switched access. Additionally, this will ensure that when the INVITE sent from the MSC Server is received by the EATF, the EATF can correlate this message with the ongoing session using the instance identifier according to existing procedures. This solution also provides the advantage that it enables access transfer of an emergency call back session even if the home network does not support SRVCC session transfer or SRVCC session transfer of IMS emergency sessions. Additionally, this solution can be implemented without any changes to the IMS emergency registration procedures.

As a further alternative to the solution described with reference to FIG. 6, the E-CSCF can provide the address of the EATF to the P-CSCF in an informational response (i.e. a 1XX response), such as a SIP 180 Ringing response message, or a success response (i.e. a 2XX response), such as a SIP 202 Accepted response message, sent during the establishment of the emergency call session between the UE and the PSAP. The P-CSCF can then store the address of the EATF for the duration of the emergency registration and send the SIP INVITE message requesting the establishment of an emergency call back session directly to the EATF (i.e. without the need for the SIP INVITE message to traverse the E-CSCF).

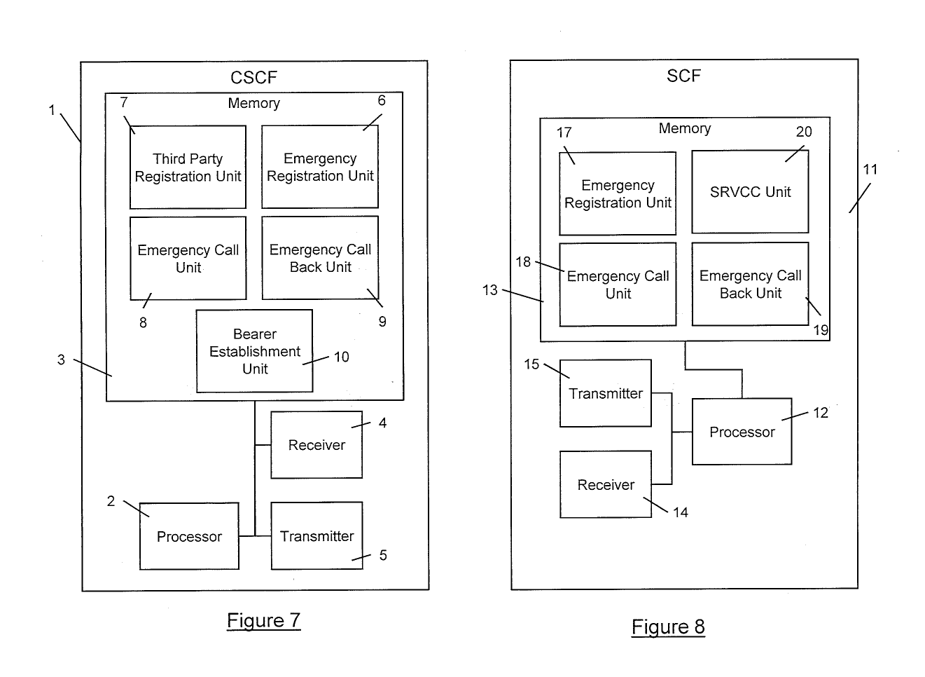

FIG. 7 illustrates schematically an example of an CSCF 1 suitable for implementing the methods described above. The CSCF 1 can be implemented as a combination of computer hardware and software, and can be configured to operate as either an S-CSCF or a P-CSCF in accordance with the solutions described above.

The CSCF 1 comprises a processor 2, a memory 3, a receiver 4 and a transmitter 5. The memory 3 stores the various programs/executable files that are implemented by the processor 2, and also provides a storage unit for any required data. The programs/executable files stored in the memory 3, and implemented by the processor 2, include one or more of, but are not limited to, an Emergency Registration Unit 6, a Third Party Registration Unit 7, an Emergency Call Unit 8, an Emergency Call Back Unit 9 and a Bearer Establishment Unit 10. The Emergency Registration Unit 6 is configured to handle requests for emergency registration that are received by the CSCF 1. For example, the Emergency Registration Unit 6 can determine if the request for emergency registration includes the address of a session continuity function (e.g. an ACTF or an EATF) in the Path header field, and thereby determine that the request should be sent to the session continuity function. The Third Party Registration Unit 7 is configured to perform a third party registration to an SCC AS, if required, and to include a routing number (STN-SR) of a session continuity function (e.g. an ACTF) in the request for third party registration. The Emergency Call Unit 8 is configured to handle the establishment of an emergency call session. For example, if required, the Emergency Call Unit 8 can include the address of a session continuity function (e.g. an EATF) in a request for establishment of an emergency call session that is to be sent to an E-CSCF. The Emergency Call Back Unit 9 is configured to handle the establishment of an emergency call back session. For example, the Emergency Call Back Unit 9 can ensure that a session continuity function (e.g. an ACTF or an EATF) is included in the signalling path of a request for establishment of an emergency call back session. The Bearer Establishment Unit 10 is configured to create any bearers that are required. For example, when establishing an emergency call back session, the Bearer Establishment Unit 10 can setup either an emergency bearer or a non-emergency bearer for the emergency call back session in accordance with the solutions described above.

FIG. 8 illustrates schematically an example of a session continuity function (SCF) 11 suitable for implementing the methods described above. The SCF 11 can be implemented as a combination of computer hardware and software, and can be configured to operate as either an ACTF or an EATF in accordance with the solutions described above. The SCF 11 comprises a processor 12, a memory 13, a receiver 14 and a transmitter 15. The memory 13 stores the various programs/executable files that are implemented by the processor 12, and also provides a storage unit for any required data. The programs/executable files stored in the memory 13, and implemented by the processor 12, include one or more of, but are not limited to, an Emergency Registration Unit 17, an Emergency Call Unit 18, an Emergency Call Back Unit 19, and an SRVCC Unit 20. The Emergency Registration Unit 17 is configured to handle requests for emergency registration that are received by the SCF 11. For example, the Emergency Registration Unit 17 can ensure that the SCF 11 is include the address of the SCF 11 in the Path header field of a request for emergency registration, and thereby ensure that is also included in the signalling path of any subsequent request for establishment of an emergency call back session.

In addition, the Emergency Registration Unit 17 can construct the Path header field of a request for emergency registration such that it can map the value of the Path header field to the “sip.instance” included in the request for emergency registration. Furthermore, if required, the Emergency Registration Unit 17 can include a routing number (e.g. STN-SR) of the SCF 11 in the request for emergency registration. The Emergency Call Unit 18 is configured to handle any requests for establishment of an emergency call session that are received by the SCF 11. The Emergency Call Back Unit 19 is configured to handle any requests for establishment of an emergency call back session that are received by the SCF 11. For example, upon receipt of a request for establishment of an emergency call back session, the Emergency Call Back Unit 19 can anchor the emergency call back session at the SCF 11 prior to forwarding the request. The SRVCC Unit 20 is configured to implement SRVCC for an emergency call session or an emergency call back session, should an access transfer be required.

It will be appreciated by the person of skill in the art that various modifications may be made to the above-described embodiments without departing from the scope of the present invention. For example, whilst the above-described embodiments refer to specific entities within an IP Multimedia Subsystem, such as the ATCF, E-CSCF, EATF and SCC AS, it is possible that the names used to refer to one or more of these entities could change, or that the functionality of one or more of these entities is combined with that of another entity. In addition, whilst the session continuity function has been used herein to refer to an IMS entity providing session continuity should access transfer from a packet switched access to a circuit switched access be required, such as an ACTF or EATF, such an entity could equally be referred to as an access transfer function.

When a node or element is referred to as being “connected”, “coupled”, “responsive”, or variants thereof to another node or element, it can be directly connected, coupled, or responsive to the other node or intervening nodes may be present. In contrast, when a node or element is referred to as being “directly connected”, “directly coupled”, “directly responsive”, or variants thereof to another node or element, there are no intervening nodes or elements present. Like numbers refer to like nodes or elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, nodes, steps, components or functions but does not preclude the presence or addition of one or more other features, integers, nodes, steps, components, functions or groups thereof.

Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer readable medium may include an electronic, magnetic, optical, electromagnetic, or semiconductor data storage system, apparatus, or device. More specific examples of the computer readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

1. A method of operating a Call Session Control Function, CSCF, of an IP Multimedia Subsystem, IMS, network, the method comprising:
participating in IMS emergency registration of a user equipment, UE;
receiving a request for establishment of an emergency call back session intended for the UE; and
forwarding the request for establishment of an emergency call back session towards a session continuity function, the session continuity function providing session continuity for IMS sessions that require access transfer from a packet switched access to a circuit switched access.

2. A method as claimed in claim 1, wherein the CSCF is a Serving Call Session Control Function, S-CSCF, located within a home IMS of the UE.

3. A method as claimed in claim 2, and further comprising:
receiving a request for IMS emergency registration of the UE from the session continuity function, the request for IMS emergency registration including an address of the session continuity function;
storing the address of the session continuity function; and
for any subsequently received session establishment request that is intended for the UE, determining if the request relates to an emergency call back session and, if so, responding by forwarding the request to the address of the session continuity function.

4. A method as claimed in claim 3, wherein the session continuity function is an Access Transfer Control Function, ATCF, located in a serving network providing the UE with access to the home IMS.

5. A method as claimed in claim 3, wherein the session continuity function is an Emergency Access Transfer Function, EATF, located in a serving network providing the UE with access to the home IMS.

6. A method as claimed in claim 1, wherein the CCSF CSCF is a Proxy Call Session Control Function, P-CSCF, located in a serving network that is providing the UE with access to the home IMS.

7. A method as claimed in claim 6, and further comprising:
following IMS emergency registration of the UE, for any received session establishment request that is intended for the UE, determining if the request has been routed over the IMS emergency registration; and
if so, responding by forwarding the request towards the session continuity function (C5).

8. A method as claimed in claim 7, wherein the step of forwarding the request towards the session continuity function comprises:
sending the request for establishment of an emergency call back session to an Emergency Call Session Control Function, E-CSCF, located in the serving network, to cause the E-CSCF to forward the request to an Emergency Access Transfer Function, EATF.

9. A method as claimed in claim 7, and further comprising:
following IMS emergency registration of the UE, receiving a response to a request for establishment of an emergency call session intended for the UE from an Emergency Call Session Control Function, E-CSCF, located in the serving network, the response including the address of an Emergency Access Transfer Function, EATF; and
storing the address of the EATF.

10. A method as claimed in claim 9, wherein the step of forwarding the request towards the session continuity function comprises:
forwarding the request to the stored address of the EATF.

11. A method of operating a session continuity function of an IP Multimedia Subsystem, IMS, network, the session continuity function providing session continuity for IMS sessions that require access transfer from a packet switched access to a circuit switched access supporting access, the method comprising:
receiving a request for IMS emergency registration of a user equipment, UE;
including the address of the session continuity function in the request for IMS emergency registration; and
forwarding the request for IMS emergency registration towards a home IMS of the UE;
wherein the inclusion of the address of the session continuity function in the request for IMS emergency registration operates to cause a subsequent emergency call back session involving the UE to be routed via the session continuity function.

12. A method as claimed in claim 11, wherein the session continuity function is an Access Transfer Control Function, ATCF.

13. A method as claimed in claim 11, wherein the session continuity function is an Emergency Access Transfer Function, EATF.

14-16. (canceled)

17. An apparatus configured to operate as a Call Session Control Function, CSCF, of an IP Multimedia Subsystem, IMS, network, the apparatus comprising:
a processor configured to participate in IMS emergency registration of a user equipment, UE;
a receiver configured to receive a session establishment request for establishment of an emergency call back session intended for the UE; and
a transmitter configured to forward the request for establishment of an emergency call back session towards a session continuity function, the session continuity function providing session continuity for IMS sessions that require access transfer from a packet switched access to a circuit switched access.

18. An apparatus as claimed in claim 17, wherein the apparatus is configured to operate as a Serving Call Session Control Function, S-CSCF, for location within a home IMS of the UE.

19. An apparatus as claimed in claim 17, wherein the receiver is further configured to receive a request for IMS emergency registration of the UE from the session continuity function, the request for IMS emergency registration including an address of the session continuity function, and the apparatus further comprises a memory that operates to store the address of the session continuity function.

20. An apparatus as claimed in claim 19, wherein the processor is configured to, determine if any subsequently received request that is intended for the UE relates to an emergency call back session and, if so, to respond by causing the request to be forwarded to the address of the session continuity function.

21. An apparatus as claimed in claim 17, wherein the apparatus is configured to operate as a Proxy Call Session Control Function, P-CSCF, for location within a serving network that is providing the UE with access to a home IMS.

22. An apparatus as claimed in claim 21, wherein the processor is configured to, determine if any received request that is intended for the UE has been routed over the IMS emergency registration and, if so, to respond by causing the request to be forwarded towards the session continuity function.

23. An apparatus as claimed in claim 22, wherein the processor is configured to cause the request for establishment of an emergency call back session to be sent to an Emergency Call Session Control Function, E-CSCF, located in the serving network, so that that the E-CSCF can forward the request to an Emergency Access Transfer Function, EATF.

24. An apparatus as claimed in claim 22, wherein:
the receiver is configured to receive a response to a request for establishment of an emergency call session intended for the UE from an Emergency Call Session Control Function, E-CSCF, located in the serving network, the response including the address of an Emergency Access Transfer Function, EATF; and
the apparatus further comprises a memory that operates to store the address of the EATF.

25. An apparatus as claimed in claim 24, wherein the processor is configured to cause the request for establishment of an emergency call back session to be sent to the stored address of the EATF.

26. An apparatus configured to operate as a session continuity function of an IP Multimedia Subsystem, IMS, network, the session continuity function providing session continuity for IMS sessions that require access transfer from a packet switched access to a circuit switched access supporting access, the apparatus comprising:
a receiver configured to receive a request for IMS emergency registration of a user equipment, UE;
a processor configured to include the address of the session continuity function in the request for IMS emergency registration so that a subsequent request for an emergency call back session involving the UE will be routed via the session continuity function; and
a transmitter configured to forward the request for IMS emergency registration towards a home IMS of the UE.

27. An apparatus as claimed in claim 26, wherein the apparatus is configured to operate as an Access Transfer Control Function, ATCF.

28. An apparatus as claimed in claim 26, wherein the apparatus is configured to operate as an Emergency Access Transfer Function, EATF.

29-31. (canceled)
